(19) United States
(12) Patent Application Publication
(10) Pub. No.: US 2021/0114810 A1
(43) Pub. Date: Apr. 22, 2021

(54) ROBOT SYSTEM, ROBOT CONTROL METHOD, AND STORAGE MEDIUM

(71) Applicant: TOYOTA JIDOSHA KABUSHIKI KAISHA, Toyota-shi (JP)

(72) Inventors: Tomohito MATSUOKA, Nagoya-shi (JP); Nobuyuki TOMATSU, Nagoya-shi (JP); Yasutaka ETOU, Okazaki-shi (JP); Masanobu OHMI, Kasugai-shi (JP); Manabu YAMAMOTO, Toyota-shi (JP); Seiichi TSUNODA, Nissin-shi (JP); Keima FUKUNAGA, Toyota-shi (JP); Takuya WATABE, Chofu-shi (JP); Makoto KAKUCHI, Toyota-shi (JP); Kunihiro IWAMOTO, Nagakute-shi (JP); Daisuke SATO, Toyota-shi (JP); Shunji INOUE, Okazaki-shi (JP); Kenta MIYAHARA, Toyota-shi (JP); Satoshi OKAMOTO, Nagoya-shi (JP); Jiro GOTO, Seto-shi (JP); Terumi UKAI, Toyokawa-shi (JP); Tetsuya TAIRA, Nagakute-shi (JP); Daisaku HONDA, Kasugai-shi (JP); Masato ENDO, Chofu-shi (JP); Takashi HAYASHI, Nagoya-shi (JP); Suguru WATANABE, Nagoya-shi (JP); Yohei TANIGAWA, Toyota-shi (JP)

(73) Assignee: TOYOTA JIDOSHA KABUSHIKI KAISHA, Toyota-shi (JP)

(21) Appl. No.: 17/069,983

(22) Filed: Oct. 14, 2020

(30) Foreign Application Priority Data
Oct. 21, 2019 (JP) 2019-192056

(51) Int. Cl. B65G 1/137; G05D 1/02

(52) U.S. Cl. CPC B65G 1/1375; G05D 1/0291

(57) ABSTRACT

A robot system includes a robot control device to link a plurality of transport robots having a function of traveling with a package being loaded. A task acquisition unit acquires a task to be performed. A notification unit notifies the transport robot of action details which are assigned regarding the task. The transport robot takes an action in link with another transport robot according to the notified action details.

### CROSS-REFERENCE TO RELATED APPLICATION

This application claims priority to Japanese Patent Application No. 2019-192056 filed on Oct. 21, 2019, incorporated herein by reference in its entirety.

### BACKGROUND

### 1. Technical Field

The disclosure relates to a robot system, a robot control method, and a storage medium for linking a plurality of transport robots to each other.

### 2. Description of Related Art

Japanese Patent No. 6336235 discloses an article transport robot including a bottom, a first column and a second column extending vertically from both ends of the bottom in a horizontal direction, and, respectively, an article storage portion in which an opening is formed by a top connected to respective upper ends of the first column and the second column, and fixing portions provided in a pair on the first column and the second column with the opening being interposed therebetween and fixing an article storage aid tool.

### SUMMARY

In Japanese Patent No. 6336235, it is assumed that a use scene in which an article transport robot travels following a shopping user. A useful system can be expected to be constructed in various scenes by linking a plurality of robots capable of autonomous traveling with packages being loaded.

Therefore, the disclosure provides a robot system and the like for linking a plurality of transport robots to each other.

According to a first aspect, the disclosure relates to a robot system that links a plurality of transport robots having a function of traveling with a package being loaded. The robot system includes an acquisition unit and a notification unit. The acquisition unit is configured to acquire a task to be performed, and the notification unit is configured to notify the transport robot of action details which are assigned regarding the task. The transport robot takes an action in link with another transport robot according to the notified action details.

According to a second aspect, the disclosure relates to a method for controlling a transport robot having a function of traveling with a package being loaded. The method includes acquiring a task to be performed, assigning action details for performing the task to the transport robot, and notifying the transport robot of action details which are assigned regarding the task. The transport robot takes an action in link with another transport robot according to the notified action details.

According to a third aspect, the disclosure relates to a non-transitory computer-readable storage medium storing a computer program. The non-transitory computer-readable storage medium implements the control method when the computer program is executed by a processor.

According to the aspects of the disclosure, a robot system for linking a plurality of transport robots to each other is provided.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIGS. 1A and 1B are perspective views of a transport robot of an embodiment;

FIGS. 2A and 2B are perspective views of the transport robot in an upright standing position;

FIG. 3 is a perspective view of the transport robot loaded with packages;

FIGS. 4A and 4B are diagrams illustrating a relative movement of a main body with respect to a traveling mechanism;

FIGS. 5A and 5B are diagrams illustrating a structure of the transport robot;

FIG. 6 is a diagram illustrating functional blocks of the transport robot;

FIG. 7 is a schematic diagram illustrating an outline of a robot system of an embodiment;

FIG. 8 is a diagram illustrating functional blocks of a robot control device;

FIG. 9 is a diagram illustrating a state in which a plurality of transport robots are traveling;

FIG. 10 is a diagram illustrating a state in which one transport robot is stopped at a blocking position;

FIG. 11 is a diagram showing a state in which three transport robots are stopped at the blocking position;

FIG. 12 is a diagram illustrating a state where road-blocking of a blocking position is completed by six transport robots;

FIG. 13 is a diagram illustrating an example of a virtual route;

FIG. 14 is a diagram illustrating a state in which a plurality of transport robots form a route;

FIGS. 15A and 15B are diagrams illustrating an example of the transport robot having an X-ray inspection function; and

FIG. 16 is a diagram illustrating a state where two transport robots perform an X-ray inspection while the transport robots are moving.

### DETAILED DESCRIPTION OF EMBODIMENTS

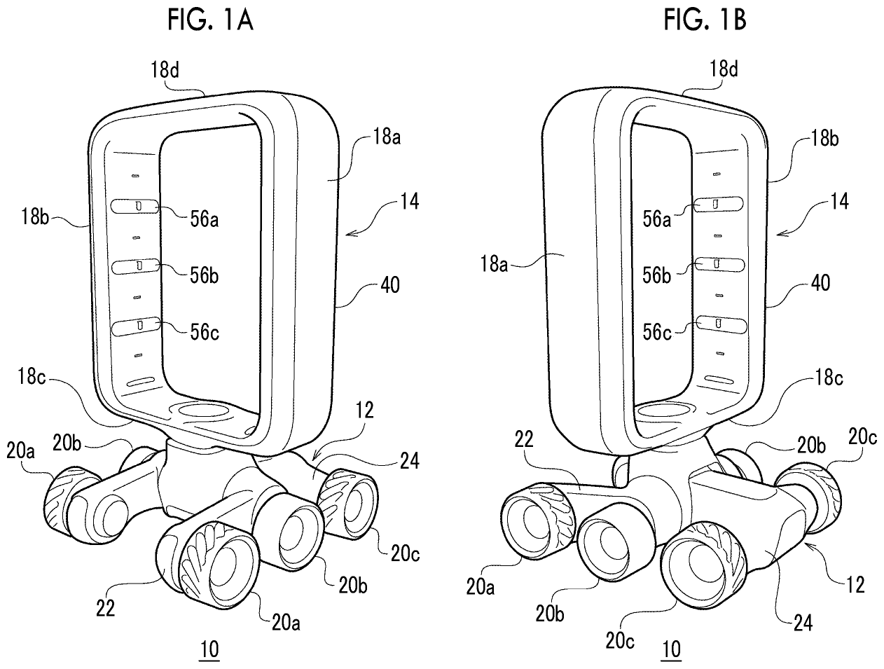

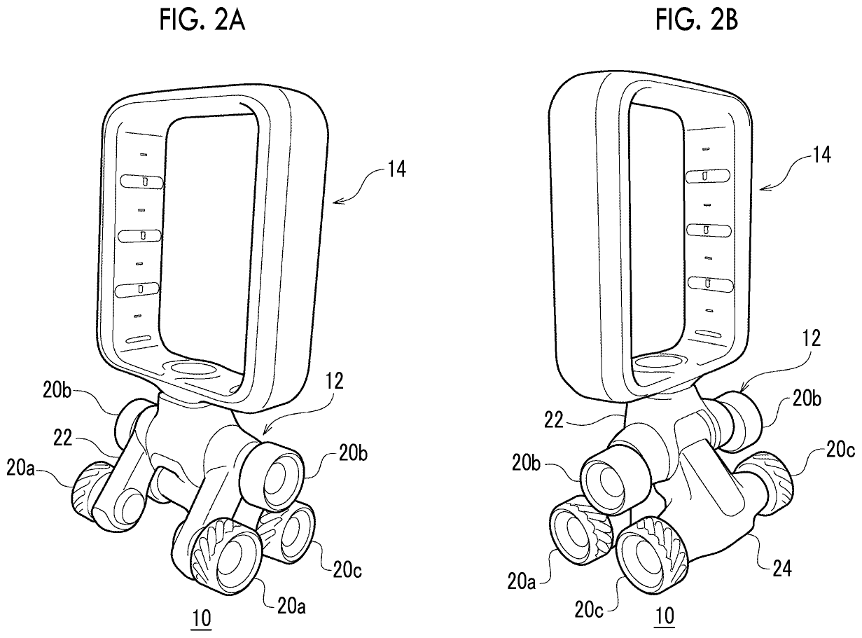

FIGS. 1A and 1B are perspective views of a transport robot 10 according to an embodiment. The height of the transport robot 10 may be, for example, about 1 to 1.5 meters. The transport robot 10 includes a traveling mechanism 12 having an autonomous traveling function, and a main body 14 which is supported by the traveling mechanism 12 and on which an object such as a package is loaded. The traveling mechanism 12 includes a first wheel body 22 and a second wheel body 24. The first wheel body 22 has a pair of front wheels 20a and a pair of middle wheels 20b, and the second wheel body 24 has a pair of rear wheels 20c. FIGS. 1A and 1B show a state in which front wheels 20a, middle wheels 20b, and rear wheels 20c are arranged in a straight line.

The main body 14 has a frame body 40 formed in a rectangular shape, and a housing space for loading an object such as a package is formed inside the frame body 40. The frame body 40 includes a pair of right and left side walls 18a, 18b, a bottom plate 18c connecting the pair of side walls at a lower side, and an upper plate 18d connecting the pair of side walls at an upper side. A pair of projecting strip portions (ribs) 56a, 56b, 56c (hereinafter, referred to as “projecting strip portions 56” unless otherwise distinguished) facing each other are provided on the inner surfaces of the right side wall 18a and the left side wall 18b. The main body 14 is connected to the traveling mechanism 12 to be relatively movable. The transport robot 10 according to the embodiment has a home delivery function of loading a package, autonomously traveling to a set destination, and delivering the package to a user waiting at the destination. Hereinafter, with respect to directions of the main body 14, a direction perpendicular to the opening of the frame body 40 in a state in which the main body 14 stands upright with respect to the traveling mechanism 12 is referred to as a “front-rear direction”, and a direction perpendicular to a pair of side walls is referred to as a “right-left direction”.

FIGS. 2A and 2B are perspective views of the transport robot 10 in an upright standing position. The front wheels 20a and the rear wheels 20c in the traveling mechanism 12 gets close to each other, and the first wheel body 22 and the second wheel body 24 incline with respect to the ground contact surface, whereby the transport robot 10 takes an upright standing position. For example, when the transport robot 10 reaches a destination and takes the upright standing position in front of a user at the destination, the user can easily pick up the package loaded on the main body 14, which is destined for the user himself or herself.

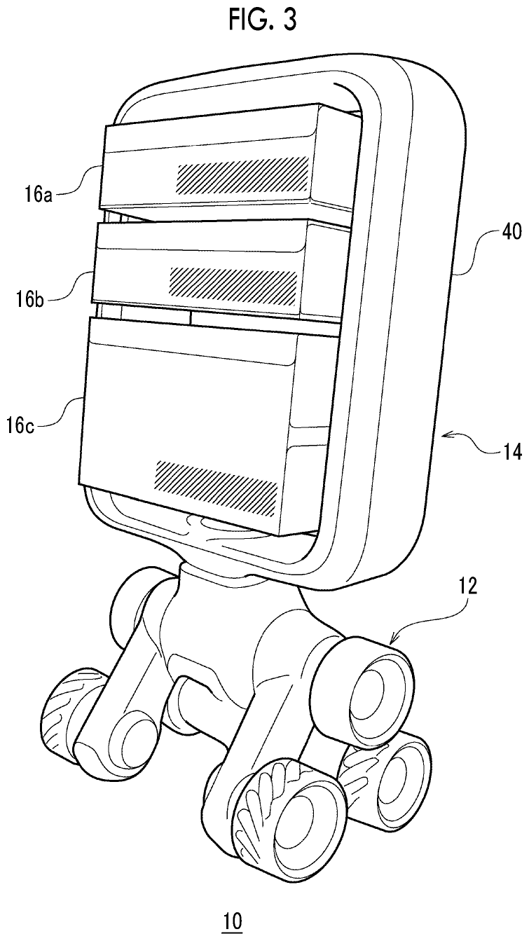

FIG. 3 is a perspective view of the transport robot 10 in the upright standing position with packages loaded. FIG. 3 shows a state where a first package 16a, a second package 16b, and a third package 16c are loaded on the main body 14. The first package 16a, the second package 16b, and the third package 16c are loaded on or engaged with the projecting strip portions 56 formed on the inner surfaces of the right side wall 18a and the left side wall 18b, thereby being loaded on the main body 14.

Although the first package 16a, the second package 16b, the third package 16c shown in FIG. 3 have a box shape, the object loaded on the main body 14 is not limited to the box shape. For example, a container for housing the object may be loaded on projecting strip portions 56, and the object may be put in the container. Further, a hook may be provided on the inner surface of an upper plate 18d of the frame body 40, the object may be put in a bag with a handle, and the handle of the bag may be hung on the hook to hang the bag.

In addition, various things other than packages can be housed in the housing space in the frame body 40. For example, by housing a refrigerator in the frame body 40, the transport robot 10 can function as a movable refrigerator. Furthermore, by housing, in the frame body 40, a product shelf loaded with products, the transport robot 10 can function as a moving store.

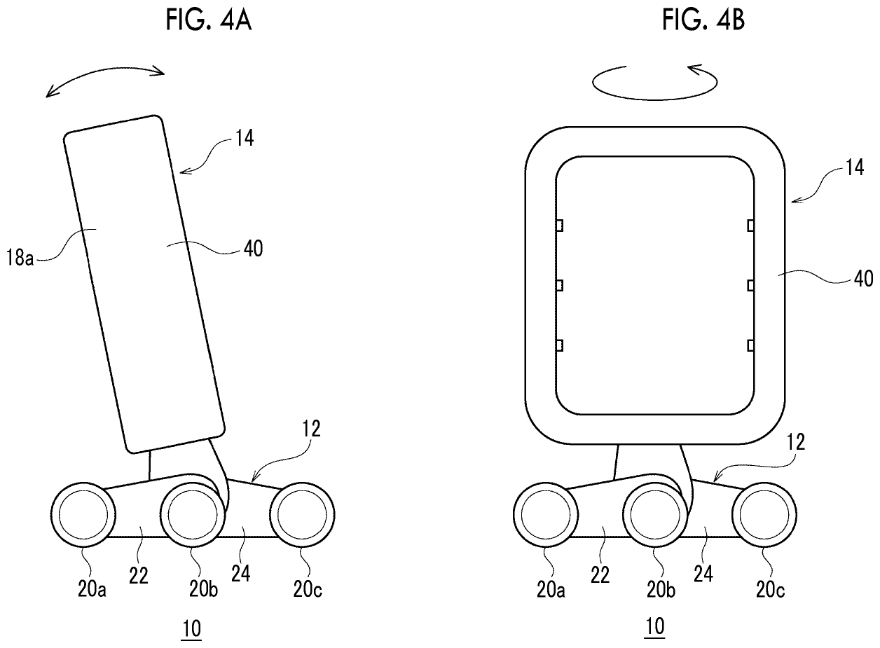

FIGS. 4A and 4B are diagrams illustrating a relative movement of the main body 14 with respect to the traveling mechanism 12. FIG. 4A shows a state where the side wall of the frame body 40 is inclined with respect to the vertical direction. The frame body 40 is supported to be relatively rotatable with respect to the traveling mechanism 12 by a connecting shaft extending in the right-left direction, and can be inclined in any of the front-rear directions.

FIG. 4B shows a state in which the frame body 40 is rotated by about 90 degrees around a vertical axis. The frame body 40 is supported to be relatively rotatable with respect to the traveling mechanism 12 by a connecting shaft extending in a direction perpendicular to the traveling mechanism 12, and the frame body 40 rotates as shown in FIG. 4B since the frame body 40 and the traveling mechanism 12 rotates relatively to each other around the connecting shaft. The frame body 40 may be rotatable 360 degrees.

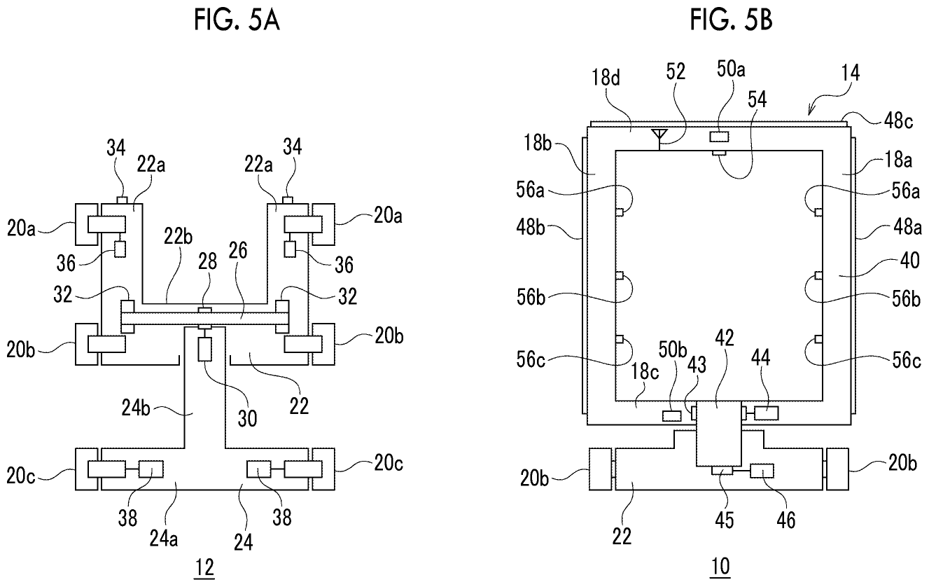

FIGS. 5A and 5B are diagrams illustrating a structure of the transport robot 10. FIG. 5A shows the structure of the traveling mechanism 12, and FIG. 5B mainly shows the structure of the main body 14. Actually, a power supply and a controller are provided in the traveling mechanism 12 and the main body 14, but are omitted in FIGS. 5A and 5B.

As shown in FIG. 5A, the traveling mechanism 12 includes front wheels 20a, middle wheels 20b, rear wheels 20c, a first wheel body 22, a second wheel body 24, a shaft 26, a coupling gear 28, a standing actuator 30, shaft supports 32, object detection sensors 34, front wheel motors 36 and rear wheel motors 38.

The first wheel body 22 has a pair of side members 22a and a cross member 22b connecting the side members 22a and extending in the vehicle width direction. The side members 22a are provided to extend from both ends of the cross member 22b in a direction perpendicular to the cross member 22b. The front wheels 20a is provided at the positions of the front ends of the side members 22a, respectively, and the middle wheels 20b is provided at the positions of both ends of the cross member 22b. A front wheel motor 36 that rotates a wheel shaft is provided on each of the front wheels 20a.

The second wheel body 24 has a cross member 24a extending in the vehicle width direction, and a connecting member 24b extending from a center position of the cross member 24a in a direction perpendicular to the cross member 24a. The connecting member 24b is inserted into the cross member 22b of the first wheel body 22, and is connected to the first wheel body 22 to be relatively rotatable. The rear wheels 20c are provided at both ends of the cross member 24a, respectively.

The rear wheel motors 38 for rotating a wheel shaft is provided on the rear wheels 20c, respectively. The front wheels 20a and the rear wheels 20c can be independently rotated by the respective motors, and the traveling mechanism 12 can turn right or left depending on the difference in the amount of rotation between the right and left wheels.

The shaft 26 extending in the vehicle width direction and the shaft supports 32 for supporting both ends of the shaft 26 are provided inside the cross member 22b. The connecting member 24b of the second wheel body 24 is rotatably connected to the shaft 26 by the coupling gear 28. The standing actuator 30 can rotate the connecting member 24b around the shaft 26. The first wheel body 22 and the second wheel body 24 can be relatively rotated by the driving of the standing actuator 30 to take the upright standing position shown in FIGS. 2A and 2B and to return to the horizontal position shown in FIGS. 1A and 1B from the upright standing position.

The traveling mechanism 12 has a rocker bogie structure capable of traveling on a step on a road or the like. The shaft 26 that connects the first wheel body 22 and the second wheel body 24 is offset from the wheel shaft of the middle wheels 20b, and is positioned between the wheel shaft of the front wheels 20a and the wheel shaft of the middle wheels 20b in a direction perpendicular to the vehicle width. Thus, the first wheel body 22 and the second wheel body 24 can be bent to the road surface shape during traveling, with reference to the shaft 26 as a supporting point.

The object detection sensors 34 are provided on the first wheel body 22 and detect objects in the traveling direction. The object detection sensor 34 may be a millimeter wave radar, an infrared laser, a sound wave sensor, or the like, or may be a combination thereof. The object detection sensor 34 may be provided at various positions on the first wheel body 22 and the second wheel body 24 to make a detection of a rearward or lateral object, in addition to the front portion of the first wheel body 22.

As shown in FIG. 5B, the transport robot 10 includes the frame body 40, the connecting shaft 42, outer peripheral teeth 43, a rotary actuator 44, a connecting shaft 45, a tilt actuator 46, a first camera 50a, a second camera 50b, and a communication unit 52. In the frame body 40, a right-side display 48a, a left-side display 48b, and a upper-side display 48c (hereinafter, referred to as “displays 48” unless otherwise distinguished), a hook 54, the first projecting strip portions 56a, the second projecting strip portions 56b, and the third projecting strip portions 56c are provided. For convenience of description, in FIG. 5B, the connecting shaft 42, the outer peripheral teeth 43, the rotary actuator 44, the connecting shaft 45, and the tilt actuator 46 are simplified and integrally shown. However, the connecting shaft 42, the outer peripheral teeth 43, and the rotary actuator 44 may be provided separately from the connecting shaft 45 and the tilt actuator 46.

The projecting strip portions 56 are provided to project out from the inner surfaces of the right side wall 18a and the left side wall 18b to load a package or the like. The hook 54 for hanging a package is formed on the inner surface of the upper plate 18d of the frame body 40. The hook 54 may always be exposed from the inner surface of the upper plate of the frame body 40, but may be provided to be housed in the inner surface of the upper plate such that the hooks 54 can be taken out as necessary.

The right-side display 48a is provided on the outer surface of the right side wall 18a, the left-side display 48b is provided on the outer surface of the left side wall 18b, and the top-side display 48c is provided on an outer surface of the upper plate 18d. The bottom plate 18c and the upper plate 18d are provided with a first camera 50a and a second camera 50b (referred to as “camera 50” unless otherwise distinguished). It is desirable that the transport robot 10 of the embodiment is mounted with a camera in addition to the first camera 50a and the second camera 50b to capture images over 360 degrees around the frame body 40. The communication unit 52 is further provided on the upper plate 18d, and the communication unit 52 can communicate with an external server device through a wireless communication network.

The bottom plate 18c is rotatably attached to the outer peripheral teeth 43 of the connecting shaft 42 through a gear (not shown) on the rotary actuator 44, and is connected to the first wheel body 22 by the connecting shaft 42. The rotary actuator 44 rotates the frame body 40 to the connecting shaft 42 by relatively rotating the outer peripheral teeth 43 and the gear. As shown in FIG. 4B, the rotary actuator 44 allows the frame body 40 to be rotated.

The tilt actuator 46 rotates the connecting shaft 45 such that the connecting shaft 42 is inclined with respect to the vertical direction. The connecting shaft 45 extending in the right-left direction is provided integrally with the lower end of the connecting shaft 42, and the tilt actuator 46 rotates the connecting shaft 45 to implement the tilting motion of the connecting shaft 42. By tilting the connecting shaft 42, the tilt actuator 46 can tilt the frame body 40 in the front-rear direction as shown in FIG. 4A.

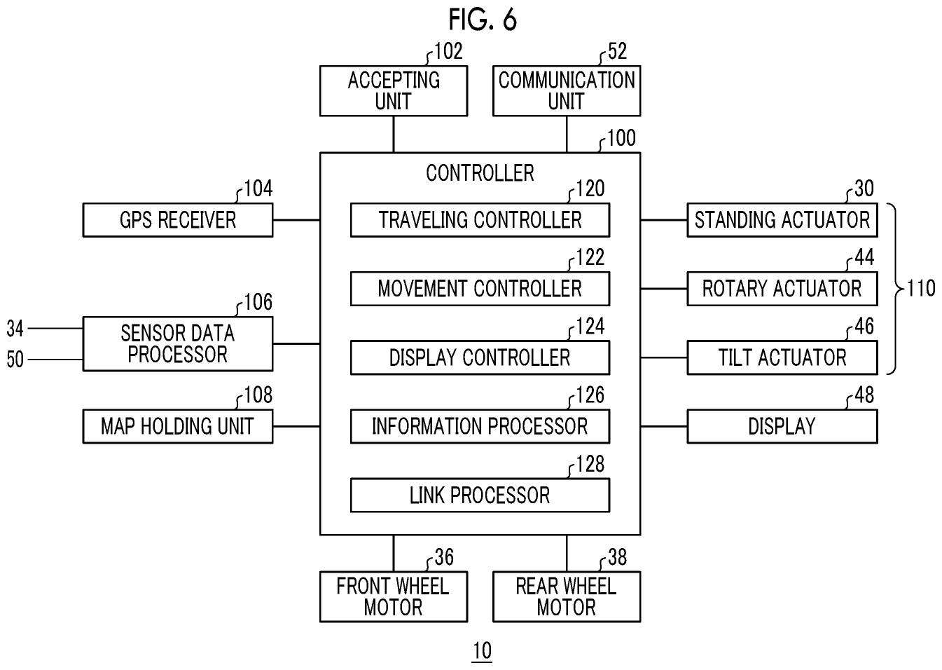

FIG. 6 shows functional blocks of the transport robot 10. The transport robot 10 includes a controller 100, an accepting unit 102, a communication unit 52, a global positioning system (GPS) receiver 104, a sensor data processor 106, a map holding unit 108, an actuator mechanism 110, a display 48, front wheel motors 36, and a rear wheel motors 38. The controller 100 includes a traveling controller 120, a movement controller 122, a display controller 124, an information processor 126 and a link processor 128, and the actuator mechanism 110 includes the standing actuator 30, a rotary actuator 44, and a tilt actuator 46. The communication unit 52 has a wireless communication function, and can communicate with the communication unit 52 of another transport robot 10 from vehicle to vehicle, and can communicate with a communication unit of a robot control device in a robot system to be described later. The GPS receiver 104 detects a current position based on a signal from a satellite. The function of the link processor 128 is implemented by executing a program for a link action mode.

In FIG. 6, each of the elements described as functional blocks that perform various processes may be configured to include a circuit block, a memory, or another LSI in terms of hardware, and is implemented by a program, or the like loaded into the memory in terms of software. Therefore, it is to be understood by those skilled in the art that these functional blocks can be implemented in various forms by hardware, software, or a combination thereof, and the disclosure is not limited thereto.

The map holding unit 108 holds map information indicating a road position. The map holding unit 108 may hold not only the road position but also map information indicating a passage position on each floor in a multi-story building such as a commercial facility.

The transport robot 10 has a plurality of action modes, and acts in the set action mode. Among the action modes, the basic action mode is an action mode in which the robot autonomously travels to a destination and delivers a package to a user waiting at the destination. Hereinafter, the basic action mode of the transport robot 10 will be described.

Basic Action Mode

The transport robot 10 is waiting at a pick-up site, and when a staff member at the pick-up site inputs a delivery destination, the transport robot 10 travels autonomously to the input delivery destination. The traveling route may be determined by the transport robot 10, or may be set by an external server device. The input of the delivery destination is performed by a predetermined wireless input tool, and when the staff member inputs the delivery destination from the wireless input tool, the communication unit 52 receives the delivery destination and notifies the traveling controller 120 of the delivery destination. The wireless input tool may be a dedicated remote controller, or may be a smartphone on which a dedicated application is installed.

The transport robot 10 includes an interface for inputting a delivery destination, and the staff member may input the delivery destination from the interface. For example, when the display 48 is a display having a touch panel, the display controller 124 may display a delivery destination input screen on the display 48, and the staff member may input a delivery destination from the delivery destination input screen. When the accepting unit 102 accepts the touch operation on the touch panel, the information processor 126 specifies the delivery destination from the touch position and notifies the traveling controller 120. When the staff member at the pick-up site loads the package on the frame body 40 and inputs the delivery destination, and then instructs the transport robot 10 to start the delivery, the traveling controller 120 starts traveling to the set delivery destination. The staff member may set a plurality of delivery destinations and load the package for each delivery destination in the housing space of the frame body 40.

The frame body 40 is provided with a mechanism for locking (fixing) the loaded package to the frame body 40. While the transport robot 10 is traveling, the package is fixed to the frame body 40 by the lock mechanism. In this way, the package does not drop during traveling and is not removed by a third party who is not the recipient.

The traveling controller 120 controls the traveling mechanism 12 to travel on the set traveling route by using the map information held in the map holding unit 108 and the current position information supplied from the GPS receiver 104. Specifically, the traveling controller 120 drives the front wheel motors 36 and the rear wheel motors 38 to cause the transport robot 10 to travel to the destination.

The sensor data processor 106 acquires information on objects existing around the transport robot 10 based on the detection data by the object detection sensor 34 and the image captured by the camera 50, and provides the information to the traveling controller 120. A target object includes a static object, such as a structure or a gutter, that hinders traveling, and an object (movable object) that can move, such as a person or another transport robot 10. The traveling controller 120 determines a traveling direction and a traveling speed to avoid collision with another object, and controls driving of the front wheel motors 36 and the rear wheel motors 38.

When the transport robot 10 reaches the destination where the user who is the recipient is, the traveling controller 120 stops driving the motors. The user has previously acquired a passcode for unlocking the package destined for the user from an external server device. When the user transmits the passcode to the transport robot 10 using a portable terminal device such as a smartphone, the communication unit 52 receives the passcode for unlocking, and the information processor 126 unlocks the package. At this time, the movement controller 122 drives the standing actuator 30 to cause the transport robot 10 to take an upright standing position. In this way, the user recognizes that the package can be received, and can easily pick up the package loaded on the main body 14, which is destined for the user himself or herself. When the package is received by the user, the traveling controller 120 travels autonomously to the next destination.

The basic action mode of the transport robot 10 has been described above, but the transport robot 10 can also perform actions in other action modes. There are various action modes of the transport robot 10, and a program for implement each action mode may be preinstalled. When the action mode is set, and the transport robot 10 acts in the set action mode.

Hereinafter, a link action mode in which the transport robots 10 act in link with each other will be described. By preparing various types of action modes in the link action mode, the usefulness of a robot system that links the transport robots 10 to each other can be enhanced.

Link Action Mode

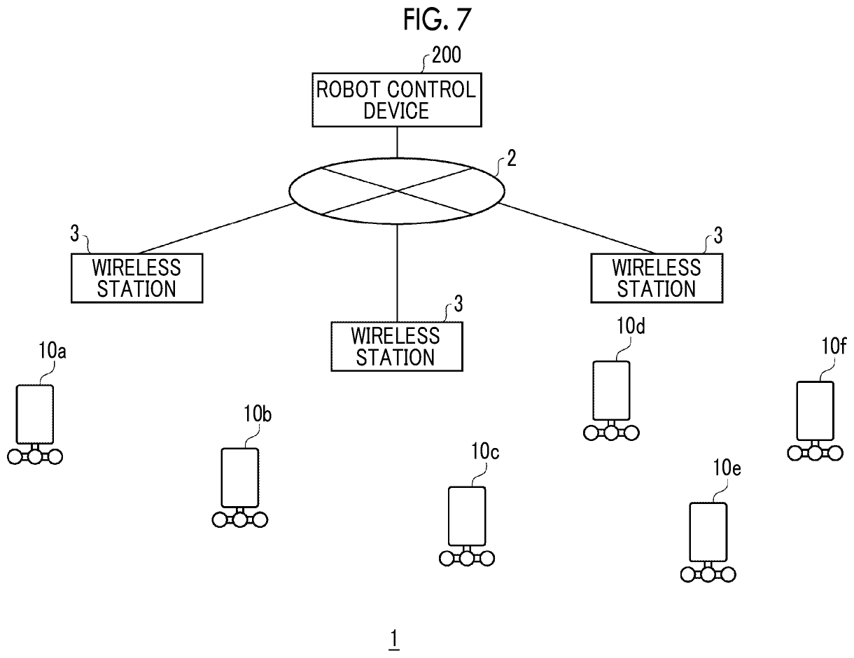

FIG. 7 shows an outline of the robot system 1 of an embodiment. The robot system 1 includes the transport robots 10a, 10b, 10c, 10d, 10e, 10f having a function of loading packages therein and autonomously traveling, and a robot control device 200 for controlling actions of the transport robots 10. The robot control device 200 is communicably connected to the transport robots 10 via a wireless station 3 as a base station through a network 2 such as the Internet, and makes the transport robots 10 link to each other.

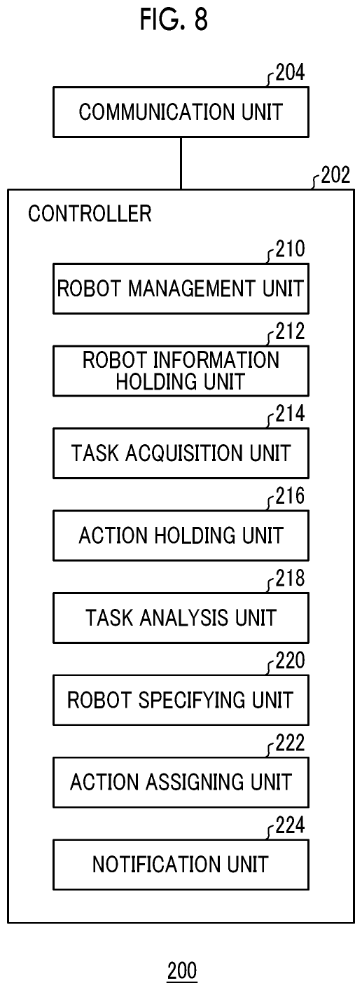

FIG. 8 shows functional blocks of the robot control device 200. The robot control device 200 includes a controller 202 and a communication unit 204. The controller 202 includes a robot management unit 210, a robot information holding unit 212, a task acquisition unit 214, an action holding unit 216, a task analysis unit 218, a robot specifying unit 220, an action assigning unit 222, and a notification unit 224. The communication unit 204 communicates with the communication unit 52 of the transport robot 10 through the network 2.

In FIG. 8, each of the elements described as functional blocks that perform various processes may be configured to include a circuit block, a memory, or another LSI in terms of hardware, and is implemented by a program, or the like loaded into the memory (storage medium) in terms of software. Therefore, it is to be understood by those skilled in the art that these functional blocks can be implemented in various forms by hardware, software, or a combination thereof, and the disclosure is not limited thereto.

The robot management unit 210 manages the positions (latitude and longitude) of the transport robots 10 in the robot system 1. The transport robots 10 may periodically transmit their own position information to the robot control device 200. In this way, the robot management unit 210 grasps the current position of each of the transport robots 10 and stores the position information on each transport robot 10 in the robot information holding unit 212. The robot management unit 210 periodically updates the position information stored in the robot information holding unit 212, and thus the robot information holding unit 212 holds the latest position information on the transport robots 10. In the link action mode, the transport robots 10 may be waiting at a predetermined position, or may be traveling around a predetermined route. The transport robot 10 for which link action mode is set activates a program for the link action mode, and the link processor 128 implements the function of executing the action details notified from the robot control device 200.

The task acquisition unit 214 acquires a task to be performed by the transport robots 10. The task acquisition unit 214 may acquire the task from a user who uses the robot system 1. For example, when the user of the robot system 1 is an administrative agency, the administrative agency inputs an instruction to perform a task related to traffic control to the robot control device 200 when the event is to be held. The task acquisition unit 214 acquires an instruction to perform the task including a task to be performed and the time for performing the task.

The action holding unit 216 holds an action of the transport robot 10 corresponding to the task. Specifically, the action holding unit 216 holds the action details to be taken by the transport robot 10 corresponding to a plurality of types of tasks. The action assigning unit 222 refers to the action details held in the action holding unit 216 to assign the action details for performing the task to the transport robots 10. The notification unit 224 notifies the transport robots 10 of the action details which are assigned regarding the task. In the robot system 1, a transport robot 10 takes an action in link with other transport robots 10 according to the notified action details. Hereinafter, a plurality of types of tasks that can be performed in the link action mode will be described.

Tasks Regarding Traffic Control of Vehicles and/or People

It is assumed that the robot system 1 is used by an administrative agency such as the police department. With the holding of the public event, the administrative agency inputs, to the robot control device 200, an instruction to perform a task to block a road around the venue of the event. The task to block the road corresponds to the task for controlling the traffic of vehicles and/or people. The task for controlling the traffic of the vehicles and/or people may include, for example, a task to control the vehicle speed.

In response to the input by the administrative agency, the task acquisition unit 214 acquires an instruction to perform a task to block the road around the venue of the event. The instruction to perform the task includes at least the information specifying the road to be blocked, the blocking position of the road, the start time and the end time of the blocking of the road.

The action holding unit 216 holds the action details that the transport robots 10 blocks the road by lining up in a row in the road-width direction, corresponding to the task (hereinafter, referred to as a “road-blocking task”) to block the road. The task analysis unit 218 acquires the action details corresponding to the road-blocking task from the action holding unit 216, and analyzes the details of the task just acquired. Specifically, the task analysis unit 218 specifies the road-widths of the plurality of blocking positions of the road to be blocked from the map information, and determines the number of transport robots 10 needed to block each of the blocking positions.

In this example, the instruction to perform the task includes the blocking positions A to G, and the task analysis unit 218 determines, from the road-width of each of the blocking positions, the number of transport robots 10 needed to block each of the blocking positions as follows.
Blocking position A: Six
Blocking position B: Six
Blocking position C: Ten
Blocking position D: Ten
Blocking position E: Eight
Blocking position F: Six
Blocking position G: Eight
   As described above, the task analysis unit 218 determines that six transport robots is needed at the blocking position A, six at the blocking position B, ten at the blocking position C, ten at the blocking position D, eight at the blocking position E, and six at the blocking position F, and eight at the blocking position G.

The robot specifying unit 220 specifies transport robots 10 to participate in performing the road-blocking task. The robot specifying unit 220 may search for the transport robots 10 located near the blocking position for each blocking position, and specify the transport robots 10 to participate in performing the task. The robot information holding unit 212 holds the latest position information of the transport robots 10, and thus, the robot specifying unit 220 may refer to the position information on the transport robots 10 held by the robot information holding unit 212 and may specify the transport robots 10 existing within a predetermined distance from each blocking position, by the number needed to block each blocking position.

The action assigning unit 222 assigns the action details for performing the task to the specified transport robots 10. When the robot specifying unit 220 determines that the transport robots 10a, 10b, 10c, 10d, 10e, 10f are to block the block position A, the action assigning unit 222 assigns, the six transport robots 10a, 10b, 10c, 10d, 10e, 10f, the action details of moving to the blocking position A and blocking the blocking position A. The notification unit 224 notifies the transport robots 10a, 10b, 10c, 10d, 10e, 10f of the action details which are assigned regarding the task, which has been received from the communication unit 204.

When the communication units 52 in the transport robots 10a, 10b, 10c, 10d, 10e, 10f receive the action details transmitted from the robot control device 200, the link processor 128 analyzes the action details. In this example, the action details are to move to the blocking position A and block the blocking position A with the six, and the link processor 128 instructs the traveling controller 120 to move to the blocking position A. In response to this instruction, the traveling controller 120 controls the traveling mechanism 12 to cause the transport robots 10 to travel to the blocking position A.

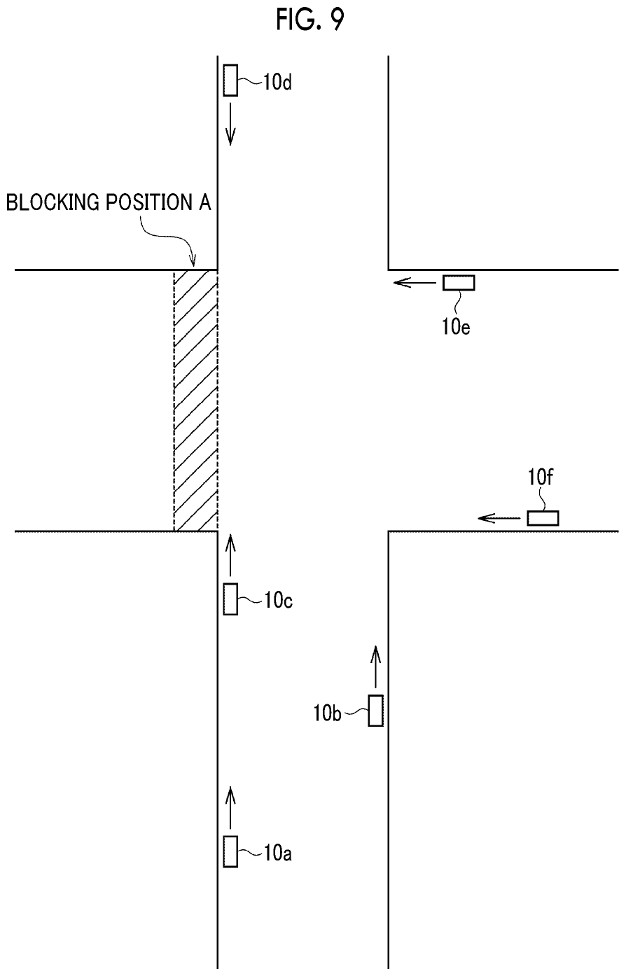

FIG. 9 shows a state in which six transport robots 10 are traveling with the blocking position A as a destination.

When the transport robots 10 arrive at the blocking position A, the link processor 128 determines the positions at which the transport robots 10 are to stop in the blocking position A based on a program according to the action details, here, a road-blocking program.

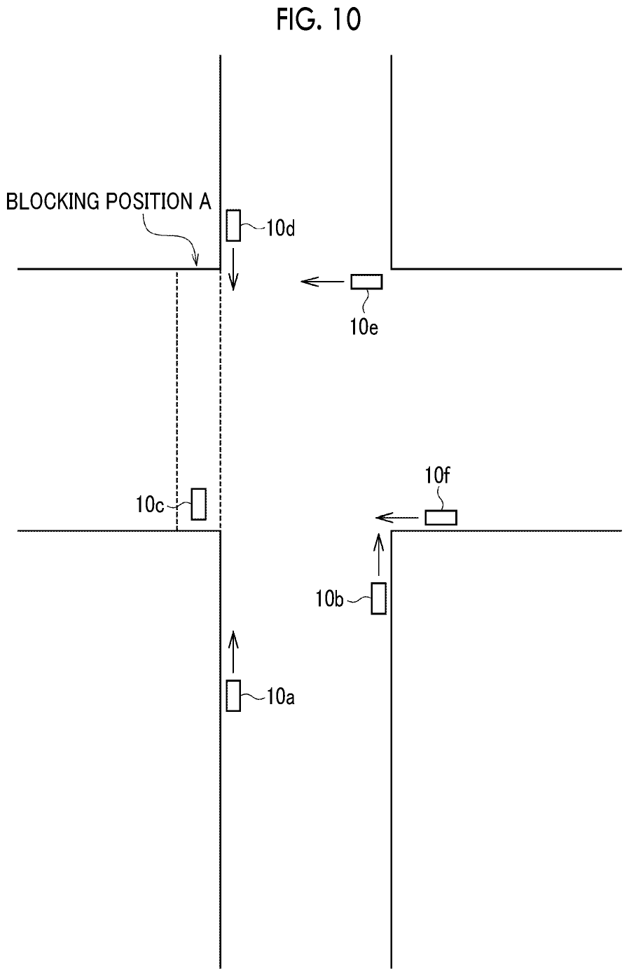

FIG. 10 shows a state where the transport robot 10c arrives at the blocking position A first and stops. When the link processor 128 in the transport robot 10c recognizes, from the image of the camera 50, that other transport robots 10 has not yet arrived at the blocking position A, the transport robot 10c determines its position at the end-most area when the blocking position A is divided into six equal parts in the road-width direction. In this way, the traveling controller 120 of the transport robot 10c stops moving at the end of the blocking position A.

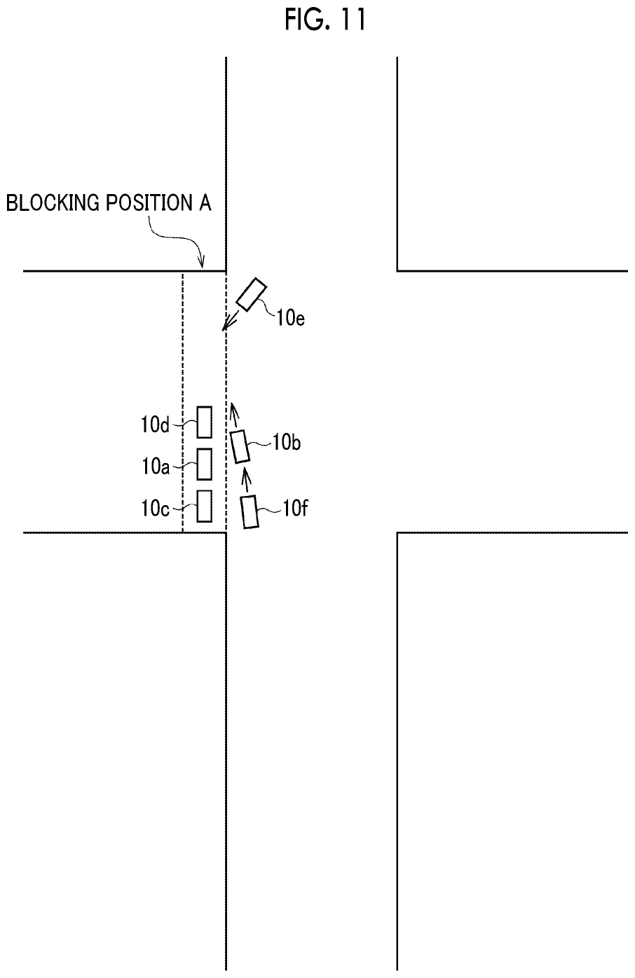

FIG. 11 shows a state in which the three transport robots 10c, 10a, 10d are stopped at the blocking position A. When the link processor 128 in the transport robot 10a recognizes, from the image of the camera 50, that the transport robot 10a has arrived second at the blocking position A, the transport robot 10a determines its position in the area next to the transport robot 10c (the second area from the end) when the blocking position A is divided into six equal parts in the road-width direction. In this way, the traveling controller 120 of the transport robot 10a stops moving next to the transport robot 10c.

When the link processor 128 in the transport robot 10d recognizes, from the image of the camera 50, that the transport robot 10d has arrived third at the blocking position A, the transport robot 10d determines its position in the area next to the transport robot 10a (the third area from the end) when the blocking position A is divided into six equal parts in the road-width direction. In this way, the traveling controller 120 of the transport robot 10d stops moving next to the transport robot 10a. As described above, the link processor 128 of each transport robot 10 determines its own stop position by the road-blocking program.

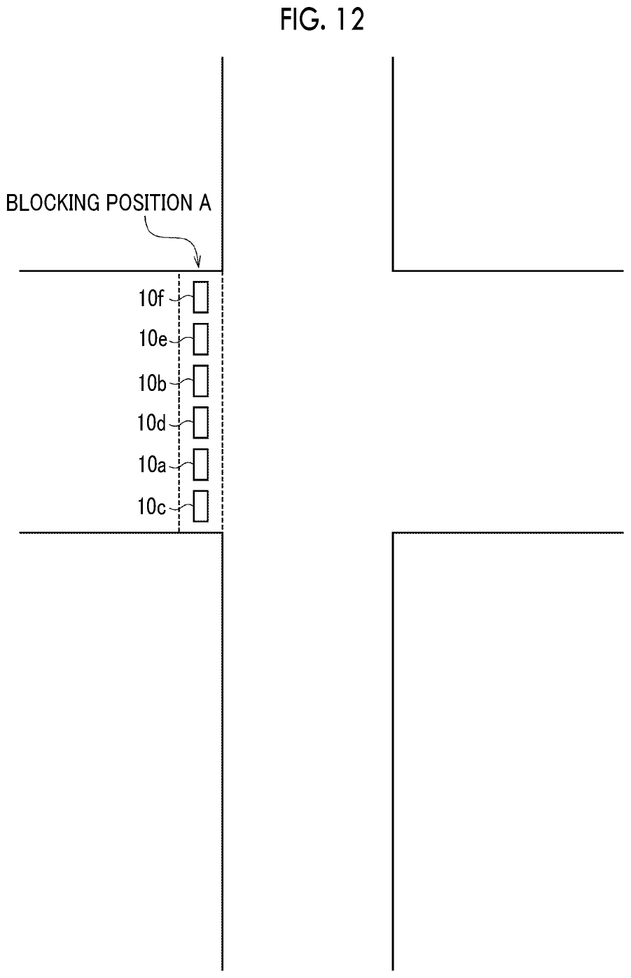

FIG. 12 shows a state where road-blocking of a blocking position A is completed by six transport robots 10. In this way, the transport robots 10a, 10b, 10c, 10d, 10e, and 10f can autonomously act according to the road-blocking program, thereby implementing the linked road-blocking action. As yet another example, for example, the transport robot 10c that has first arrived at the blocking position A may operate as a leader robot that instructs the stop position of the transport robot 10 that arrives later. In addition, the action assigning unit 222 may assign action details including the stop position of each transport robot 10 to each of the transport robots 10.

As described above, when the task acquisition unit 214 acquires the instruction to perform the task for controlling the traffic of vehicles and/or people, the action assigning unit 222 assigns, to the transport robots 10, an action of lining up in a row at a blocking position. The transport robot 10 stops in link with other transport robots 10 at the blocking position such that the transport robots 10 line up in a row in the road-width direction, according to the assigned action details. As described above, the robot system 1 can perform a task for controlling the traffic of vehicles and/or people by the transport robots 10 linking to with each other.

Tasks Regarding Traffic Guide for Vehicles and/or People

It is assumed that the robot system 1 is used by an event company that holds an event such as a concert. The event company inputs, to the robot control device 200, an instruction to perform a task to guide spectators leaving the event venue to the stop position of a shuttle bus. In response to the input, the task acquisition unit 214 acquires an instruction to perform a task to guide traffic of people. The instruction to perform the task includes at least the positions at both ends of the guideway to be formed, that is, the position of the exit of the event venue and the stop position of the shuttle bus, and the formation period of the guideway.

The action holding unit 216 holds the action details that the transport robots 10 are arranged in two rows to form a route (guideway), corresponding to the task (hereinafter, referred to as a “guidance task”) to guide the traffic of people. The task analysis unit 218 acquires the action details corresponding to the guidance task from the action holding unit 216, and analyzes the details of the task just acquired. Specifically, the task analysis unit 218 determines the route path and width of the route formed between the exit of the event venue and the stop position of the shuttle bus, and determines the number of transport robots 10 needed to form the route.

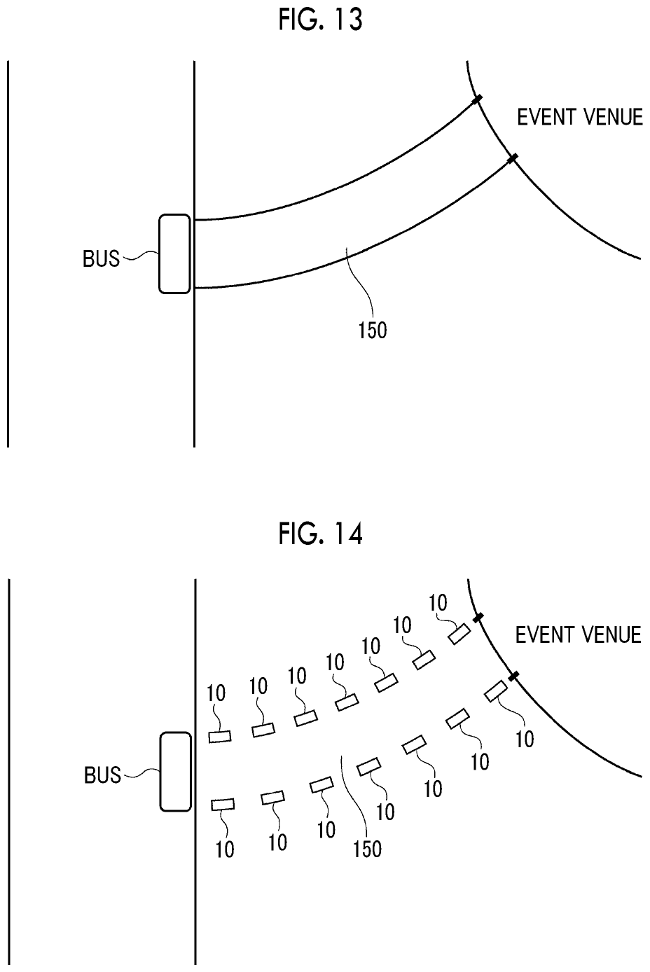

FIG. 13 shows an example of a virtual route 150 formed between an exit of a venue and a stop position of a bus. The route 150 is completed by arranging a plurality of transport robots 10 on both sides of the road width. The task analysis unit 218 determines, based on the length of the route 150, that the number of the transport robots 10 to be arranged on each side of the road widths is seven.

The robot specifying unit 220 specifies transport robots 10 to participate in performing the guidance task. The robot specifying unit 220 may search for the transport robot 10 existing near the event venue and specify the transport robot 10 to participate in performing the guidance task. The robot information holding unit 212 holds the latest position information of the transport robots 10, and thus, the robot specifying unit 220 refers to the position information on the transport robots 10 held by the robot information holding unit 212 and specifies the needed number of transport robots 10 existing within a predetermined distance from the venue. The action assigning unit 222 assigns the action details for performing the task to the specified transport robots 10. Specifically, the action assigning unit 222 assigns, to the transport robots 10, the action of forming routes 150 between the venue of the event and the stop position of the bus with 14 transport robots. The notification unit 224 notifies the 14 transport robots 10 of the action details which are assigned regarding the guidance task using the communication unit 204.

When the communication units 52 in the transport robots receive the action details transmitted from the robot control device 200, the link processor 128 analyzes the action details. In this example, the action details are to move between the exit of the event venue and the bus stop position to form a route 150 with 14 robots and the link processor 128 instructs the traveling controller 120 to move to the area between the exit of the event venue and the bus stop position. In response to this instruction, the traveling controller 120 controls the traveling mechanism 12 to cause the transport robots 10 to travel to the area between the exit of the event venue and the bus stop position.

FIG. 14 shows a state in which 14 transport robots 10 form a route 150. When the transport robots 10 arrive at the area between the event venue and the bus stop position, the link processor 128 may determine the positions at which transport robots 10 are to stop based on a program according to the action details, here, a route forming program. In the method of determining the stop position of transport robot's own, each transport robot 10 may determine its own position based on the stop position of other transport robots 10, as in the method described with reference to FIGS 10 to 12. As yet another example, the transport robot 10 that arrives first may operate as a leader robot that indicates other transport robots 10 that to be arrive later which stop positions they should be. In addition, the action assigning unit 222 may assign action details including the stop position of each transport robot 10 to each of the transport robots 10.

As described above, when the task acquisition unit 214 acquires the instruction to perform the task to guide the traffic of people, the action assigning unit 222 assigns, to the transport robots 10, the action of lining up in a row in the area where a route is to be formed. The transport robots 10 stops in two rows to form a route in link with the other transport robots 10 10 according to the assigned action details. In this way, the robot system 1 can perform the task to guide the traffic of people by the transport robots 10 linking to each other. Although the embodiment has been described with respect to the task to guide the traffic of people, the task to guide the traffic of vehicles can be similarly performed.

In addition, as an action linked to the action of guiding the traffic of people, guiding the traffic of a person may be performed by the two transport robots 10 located on both sides of the person and moving in synchronization with each other in a predetermined traveling direction.

Task Regarding X-Ray Inspection

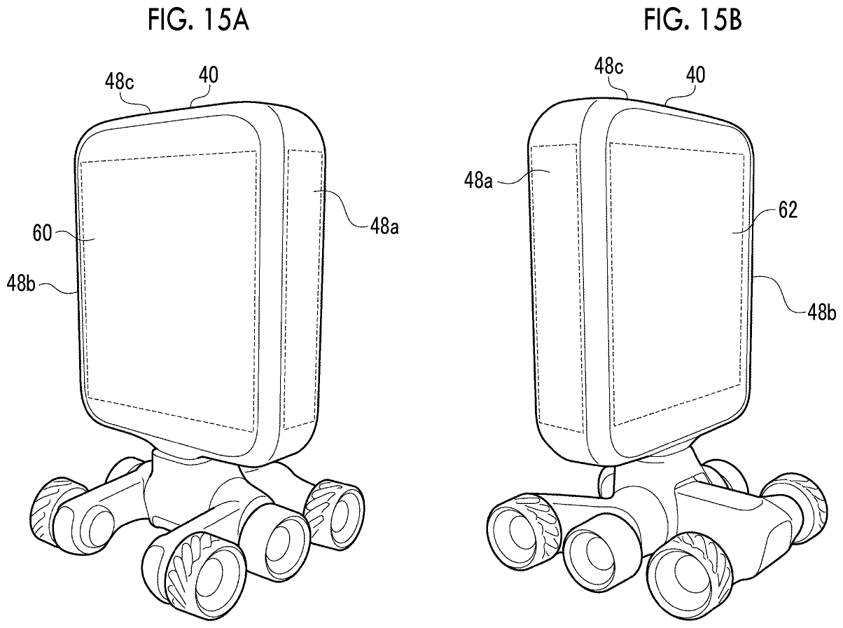

FIGS. 15A and 15B show an example of the transport robot 10 having an X-ray inspection function. FIG. 15A shows a state in which an X-ray irradiation device 60 is disposed on the front portion of the opening of the frame body 40, and FIG. 15B shows an X-ray camera 62 on the rear portion of the opening of the frame body 40. By mounting the X-ray irradiation device 60 and the X-ray camera 62 on the frame bodies 40, the transport robots 10 can function as a moving X-ray inspection device. The X-ray irradiation by the X-ray irradiation device 60 and the X-ray imaging by the X-ray camera 62 may be executed by the information processor 126.

The X-ray inspection is performed when the two transport robots 10 face each other with the target object interposed therebetween. Hereinafter, the two transport robots 10 in charge of the X-ray inspection will be referred to as transport robots 10g, 10h, respectively. At the time of X-ray inspection, the transport robot 10g and the transport robot 10h face each other at positions between which the target object is interposed, with an X-ray irradiation device 60 of the transport robot 10g and an X-ray camera 62 of the transport robot 10h facing each other. In this state, X-ray inspection is performed by the X-ray irradiation device 60 irradiating the object with X-rays and the X-ray camera 62 capturing an image. The captured X-ray image is analyzed by a sensor data processor 106 or the information processor 126.

When the robot system 1 is used as an X-ray inspection system at an airport, a factory, or the like, an instruction to perform a task to inspect a target object by X-rays is input to the robot control device 200. In the robot control device 200, the task acquisition unit 214 acquires an instruction to perform an X-ray inspection task. The instruction to perform the task includes at least position information indicating a location where the object to be inspected is arranged.

The action holding unit 216 holds the action detail of X-ray imaging while the two transport robots 10 move facing each other in response to the X-ray inspection task. The robot specifying unit 220 specifies the two transport robots 10g, 10h participating in performing the X-ray inspection task, and the action assigning unit 222 assigns the action details for performing the task, to the specified transport robots 10g, 10h. Specifically, the action assigning unit 222 assigns an action of moving to the location where target objects are arranged and performing X-ray imaging of the target objects, to the transport robots 10g, 10h. The notification unit 224 notifies the transport robots 10g, 10h of the action details which are assigned regarding the X-ray inspection task, which have been received from the communication unit 204.

When the communication units 52 in the transport robots 10g, 10h receive the action details transmitted from the robot control device 200, the link processor 128 analyzes the action details. In this example, the action detail is to perform an X-ray inspection of the target objects arranged at the location indicated in the position information, and the link processor 128 instructs the traveling controller 120 to move to the position indicated in the position information. In response to this instruction, the traveling controller 120 controls the traveling mechanism 12 to cause the transport robots 10 to travel to the location where the target objects are arranged.

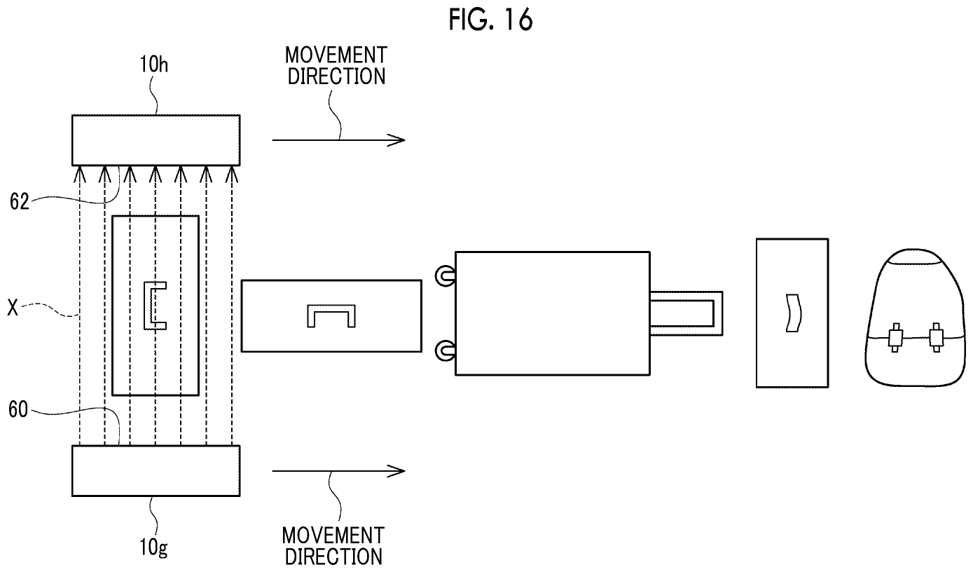

FIG. 16 shows a state where two transport robots 10 perform an X-ray inspection while the transport robots 10 are moving. When the transport robots 10 arrive at the location where the target objects to be inspected are arranged, the link processor 128 may determine their own initial positions according to a program based on the action details, here, an X-ray inspection program. For example, when the transport robot 10g arrives before the transport robot 10h, the transport robot 10g stops moving with the X-ray irradiation device 60 facing the target object, and the late transport robot 10h stops moving with the X-ray camera 62 facing the transport robot 10g at the position where the target object is interposed between the transport robot 10g and the transport robot 10h. From the state, the transport robots 10g, 10h move at a constant speed along the direction in which the target objects are arranged while maintaining the distance from each other, and during the movement of the transport robots 10g, 10h, the X-ray irradiation device 60 emits X-rays and the X-ray camera 62 images the X-rays. As described above, with the robot system 1 of the embodiment, it is possible to perform the X-ray inspection at any location without providing an X-ray inspection facility. In addition, for the initial position before the start of inspection, the action assigning unit 222 may assign the action details including the initial positions of the transport robots 10g, 10h to each of the transport robots 10 in advance.

As described above, when the task acquisition unit 214 acquires the instruction to perform the task to inspect the target object by X-rays, the action assigning unit 222 assigns, to the two transport robots 10g, 10h, the action of moving to the location where the target objects are arranged, and capturing X-ray images while moving in a state of facing each other with a target object interposed therebetween. According to the assigned action details, the two transport robots 10g, 10h face each other and capture images while moving along the direction in which the target objects are arranged, one with the X-ray irradiation device 60 and the other with the X-ray camera 62. Thus, the robot system 1 can perform a task to perform the X-ray inspection by the two transport robots 10 linking to each other.

Tasks Regarding Leading

A task will be described in which one transport robot 10 takes the lead when one or more transport robots 10 are transporting packages. For example, when the transport robot 10 transports a long-sized package that greatly protrudes from the frame body 40, the transport robot 10 cannot travel forward by a collision avoidance algorithm in the traveling controller 120 when a person exists in the traveling direction. Then, with one transport robot 10 as a lead, a speaker (not shown) is made to report that packages are being transported, and ask persons present in the traveling direction to make way for transporting. For example, the transport robot 10 serving as a lead may output a voice using a speaker saying, “packages are currently being transported, please make way for transporting”. The presence of the transport robot 10 as the lead makes it possible to carry packages smoothly.

In this case, first, the task acquisition unit 214 acquires the task to transport a package. The task analysis unit 218 analyzes the task to transport the package, and determines that a leading role is needed when the package to be transported is long or when the volume of the package is large and needs to be transported by the transport robots. The action assigning unit 222 assigns an action of moving to lead a transport robot 10 loaded with the package, to at least one transport robot 10. In this case, the transport robot 10 serving as a lead acts to notify the surrounding people that the package is being transported while moving ahead of the transport robot loaded with the package. It is noted that the transport robot 10 serving as a lead may be loaded with a package.

The disclosure has been described based on the embodiment. It should be noted that the embodiment is merely an example, and it is understood by those skilled in the art that various modifications can be made to the combination of the components and processes thereof, and that such modifications are also within the scope of the disclosure.

In the embodiment, the robot control device 200 controls transport robots 10 to link the transport robots to each other, but the linkage of the transport robots 10 may be controlled by one transport robot 10. For example, when one transport robot 10 acquires a task, the transport robot 10 that has acquired the task may operate as the robot control device 200 to control link with other transport robots 10.

What is claimed is:

1. A robot control method for controlling a transport robot having a function of traveling with a package being loaded, the method comprising:
acquiring a task to be performed;
assigning action details for performing the task to the transport robot; and
notifying the transport robot of action details which are assigned regarding the task,
wherein the transport robot takes an action in link with another transport robot according to the notified action details.

2. The robot control method according to claim 1, further comprising:
specifying a transport robot that participates in performing the task, wherein action details for performing the task are assigned to a specified transport robot.

3. The robot control method according to claim 2, wherein;
a task for guiding or controlling traffic of a person or a vehicle is acquired, and
an action of lining up in a row is assigned to a plurality of the transport robots.

4. The robot control method according to claim 2, wherein;
a task for inspecting a target object by an X ray is acquired, and
an action of two transport robots moving in a state of facing each other with the target object being interposed between the two transport robots is assigned.

5. The robot control method according to claim 2, wherein;
a task for transporting a package is acquired; and
an action of moving to lead a transport robot loaded with the package is assigned to at least one transport robot.

6. A robot system that links a plurality of transport robots having a function of traveling with a package being loaded, the robot system comprising:
an acquisition unit configured to acquire a task to be performed; and
a notification unit configured to notify the transport robot of action details which are assigned regarding the task,
wherein the transport robot takes an action in link with another transport robot according to the notified action details.

7. The robot system according to claim 6, further comprising:
a robot specifying unit configured to specify a transport robot that participates in performing the task; and
an action assigning unit configured to assign action details for performing the task to a specified transport robot.

8. The robot system according to claim 7, wherein:
the acquisition unit is configured to acquire a task for guiding or controlling traffic of a person or a vehicle; and
the action assigning unit is configured to assign an action of lining up in a row, to the transport robots.

9. The robot system according to claim 7, wherein:
the acquisition unit is configured to acquire a task for inspecting a target object by an X ray; and
the action assigning unit is configured to assign an action of two transport robots moving in a state of facing each other with the target object being interposed between the two transport robots.

10. The robot system according to claim 7, wherein:
the acquisition unit is configured to acquire a task for transporting a package; and
the action assigning unit is configured to assign an action of moving to lead a transport robot loaded with the package, to at least one transport robot.

11. A non-transitory computer-readable storage medium storing a computer program to implement the method according to claim 1 when the computer program is executed by a processor.
